(19) United States
(12) Patent Application Publication
(10) Pub. No.: US 2016/0056746 A1
(43) Pub. Date: Feb. 25, 2016

(54) APPARATUS FOR DRIVING SRM AND CONTROLLING METHOD THEREOF

(71) Applicant: SAMSUNG ELECTRO-MECHANICS CO., LTD., Suwon-Si (KR)

(72) Inventors: Joung Ho SON, Suwon-Si (KR); Kyu Dong KIM, Suwon-Si (KR); Geun Hong LEE, Suwon-Si (KR)

(73) Assignee: SAMSUNG ELECTRO-MECHANICS CO., LTD., Suwon-Si (KR)

(21) Appl. No.: 14/712,281

(22) Filed: May 14, 2015

(30) Foreign Application Priority Data
Aug. 21, 2014 (KR) 10-2014-0109069

(51) Int. Cl. H02P 25/08; H02P 6/14

(52) U.S. Cl. CPC H02P 25/085; H02P 6/14; H02P 6/145

(57) ABSTRACT

There is provided an apparatus for driving a switched reluctance motor (SRM), the apparatus including a motor driver for applying an input voltage to each phase of the SRM to drive the SRM through a switching operation, and a processor for controlling a driving state of the SRM through control of the switching operation based on a rotational speed of the SRM.

### CROSS-REFERENCE TO RELATED APPLICATION

This application claims the benefit of Korean Patent Application No. 10-2014-0109069, filed on Aug. 21, 2014, entitled “Apparatus for Driving SRM and Controlling Method Thereof” which is hereby incorporated by reference in its entirety into this application.

### BACKGROUND

The present disclosure relates to an apparatus for driving a switched reluctance motor (SRM) and a controlling method thereof.

A switched reluctance motor (hereinafter, referred to as an SRM) is a motor combined with a switching controller and includes a stator and a rotor, both of which have a salient pole type structure.

In particular, the SRM has a simple structure in that a coil is wound around only a stator portion and any coil and permanent magnet are not present at a rotor portion.

Due to the structural characteristics, the SRM is significantly advantageous in terms of its manufacture and production and has excellent starting characteristic like a direct current (DC) motor and high torque, whereas the SRM has a low need for maintenance and repair and excellent characteristic in terms of torque per unit volume, efficiency, converter rating, and so on. Accordingly, in accordance with current trends, use fields of the SRM have been increasingly widened.

The SRM has various types including a single-phase SRM, a two-phase SRM, a three-phase SRM, and so on. In particular, the two-phase SRM has a simpler driving circuit than the three-phase SRM and has received considerable attention in application fields such as a fan, a blower, and a compressor.

### RELATED ART DOCUMENT

### Patent Document

(Patent Document 1) 2001-0068827KR

### SUMMARY

An aspect of the present disclosure may provide an apparatus for driving a switched reluctance motor (SRM) and a controlling method thereof, for preventing an air suction fan from being damaged when rotational speed of the SRM exceeds predetermined speed, which may be changed according to a material or shape of the air suction fan, during driving of the air suction fan using a rotational force of the SRM.

An apparatus for driving the SRM according to an exemplary embodiment of the present disclosure may selectively convert a driving state of the SRM to a control or stop state of an advanced angle and so on based on the rotational speed of the SRM, thereby preventing increase in manufacturing costs due to manufacture of a suction fan using a material with excessive specification and so on.

In addition, the driving state of the SRM may be actively controlled along with change in rotational speed of the SRM according to a sealing degree of an intake of the suction fan so as to ensure the overall reliability of an SRM driving circuit.

According to an aspect of the present disclosure, an apparatus for driving a switched reluctance motor (SRM) may include a motor driver for applying an input voltage to each phase of the SRM to drive the SRM through a switching operation, and a processor for controlling a driving state of the SRM through control of the switching operation based on a rotational speed of the SRM.

In more detail, the processor may control an advanced angle or dwell angle of the SRM through control of the switching operation when the rotational speed of the SRM is equal to or more than first reference speed, and the processor may convert a driving state of the SRM to a stop state through control of the switching operation when the rotational speed of the SRM is equal to or more than second reference speed.

Furthermore, the processor may convert the driving state of the SRM to a stop state when the rotational speed of the SRM is equal to or more than second reference speed and the rotational speed of the SRM is maintained for first reference time.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram illustrating an apparatus for driving a switched reluctance motor (SRM) according to an exemplary embodiment of the present disclosure;

FIG. 2 is a diagram illustrating a configuration of a motor driver according to an exemplary embodiment of the present disclosure;

FIG. 3 is a diagram illustrating a method of controlling an advanced angle and dwell angle of an SRM by a motor driver according to an exemplary embodiment of the present disclosure;

FIG. 4 is a diagram illustrating a relationship between a size of an orifice (hole) of an intake and rotational speed of an SRM according to an exemplary embodiment of the present disclosure;

FIG. 5A is a diagram illustrating a relationship between rotational speed of an SRM and a size of an orifice (hole) of an intake according to an exemplary embodiment of the present disclosure, and FIG. 5B is a diagram illustrating control of an advanced angle and dwell angle of an SRM according to rotational speed of the SRM; and

FIG. 6 is a flowchart of a controlling method of a driving apparatus of an SRM according to an exemplary embodiment of the present disclosure.

### DETAILED DESCRIPTION

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present disclosure, when it is determined that the detailed description of the related art would obscure the gist of the present disclosure, the description thereof will be omitted.

Hereinafter, exemplary embodiments of the present disclosure will be described in detail with reference to the accompanying drawings. A motor used herein refers to a two-phase switched reluctance motor (hereinafter, referred to as an SRM). Here, the SRM will be described in terms of two-phase (phase A and phase B) SRM, but also corresponds to the case in which the SRM has two phase windings or more.

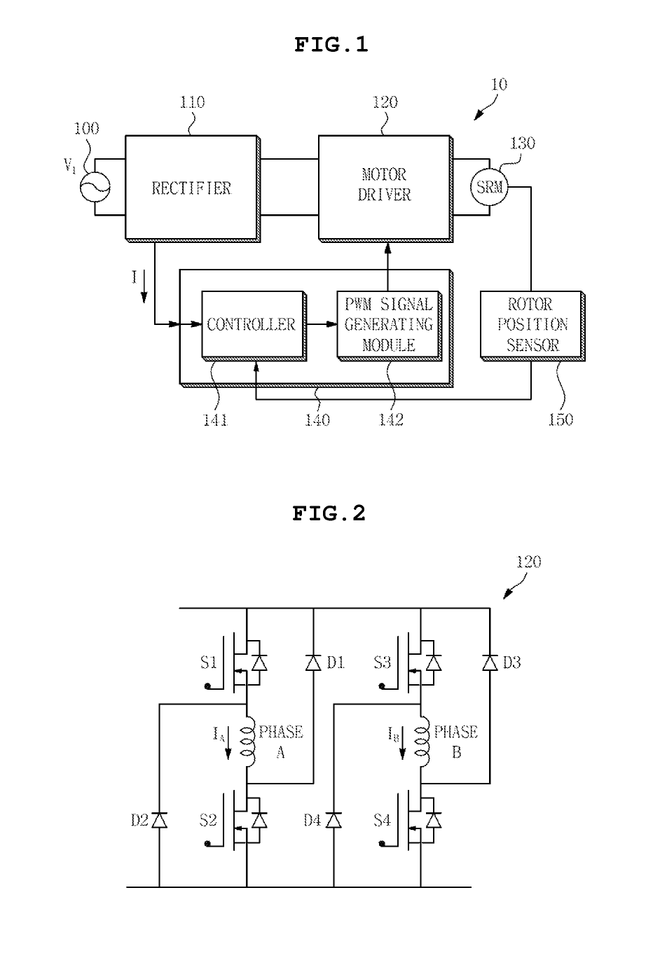

FIG. 1 is a block diagram illustrating an apparatus for driving an SRM 130 according to an exemplary embodiment of the present disclosure, and FIG. 2 is a diagram illustrating a configuration of a motor driver 120 according to an exemplary embodiment of the present disclosure.

As illustrated in FIG. 1, the driving apparatus of the SRM 130 according to an exemplary embodiment of the present disclosure includes a rectifier 110 for providing a direct current (DC) voltage, the motor driver 120 for applying the DC voltage to the SRM 130 via a switching operation, and a processor 140 for controlling the switching operation.

The rectifier 110 may include a voltage smoothing capacitor (not shown) for rectifying a prevailing voltage V_{I} (AC) to generate a DC voltage and smoothing (enhancing a power factor of DC voltage and absorbing noise) the prevailing voltage V_{I} and a bridge rectifier circuit (not shown) for rectifying the smoothed V_{I}.

The motor driver 120 applies the DC voltage to each phase of the SRM 130 via a switching operation and includes switching module (S1 to S4) and current circulating module (D1 to D4).

That is, as illustrated in FIG. 2, the switching module S1 to S4 include a first switch S1 that is connected in series to an upper portion of any one of phase windings (phase winding A) of the SRM 130, a second switch S2 that is connected in series to a lower portion of any one of phase windings (phase winding A) of the SRM 130, a third switch S3 that is connected in series to an upper portion of the other of phase windings (phase winding B) of the SRM 130, and a fourth switch S4 that is connected in series to a lower portion of the other of phase windings (phase winding B) of the SRM 130.

The current circulating module (D1 to D4) circulate current flowing in each phase winding of the SRM 130 in a predetermined direction and include a first diode D1 to a fourth diode D4. In addition, 1) the first diode D1 has a positive electrode connected to a contact between the phase winding A and the second switch S2 and a negative electrode connected to a power source unit 100, and 2) the second diode D2 has a positive electrode connected to a contact between the phase winding A and the first switch Si and a negative electrode connected to a ground terminal GND.

Here, the switching module (S1 to S4) and the current circulating module (D1 to D4) may have an asymmetrical bridge structure, as described above, but are not limited thereto.

In addition, 3) the third diode D3 has a positive electrode connected to a contact between the phase winding B and the third switch S3 and a negative electrode connected to the power source unit 100, and 2) the fourth diode D4 has a positive electrode connected to a contact between the phase winding B and the fourth switch S4 and a negative electrode connected to a ground terminal GND.

The processor 140 controls a driving state of the SRM 130 through control of the switching operation based on rotational speed of the SRM 130 and includes a controller 141 and a pulse width modulation (PWM) signal generating module 142. Here, a rotor position sensor 150 senses rotational speed of the SRM 130 and transmits the rotational speed to the processor 140.

That is, when the rotational speed of the SRM 130 is equal to or more than a first reference speed, an advanced angle or dwell angle of the SRM 130 is controlled through control of the switching operation. In addition, when the rotational speed of the SRM 130 is equal to or more than a second reference speed, a driving state of the SRM 130 is converted to a stop state through control of the switching operation.

In addition, when the rotational speed of the SRM 130 is equal to or more than the second reference speed and the rotational speed of the SRM 130 is maintained for a first reference time, the driving state of the SRM 130 may be converted to a stop state. Here, the first reference speed may correspond to the case in which the rotational speed of the SRM 130 is 55,000 RPM and the second reference speed may correspond to the case in which the rotational speed of the SRM 130 is 57,000 RPM, but the present disclosure is not limited thereto.

In more detail, when the rotational speed of the SRM 130 is equal to or more than the first reference speed, the controller 141 generates a first control signal for adjusting an advanced angle (or a leading angle) or dwell angle of the SRM 130.

In addition, the PWM signal generating module 142 transmits a PWM signal for controlling the switching operation to the motor driver based on the first control signal and controls a duty ratio of the PWM signal and timing for transmitting the PWM signal to the motor driver 120 based on the first control signal.

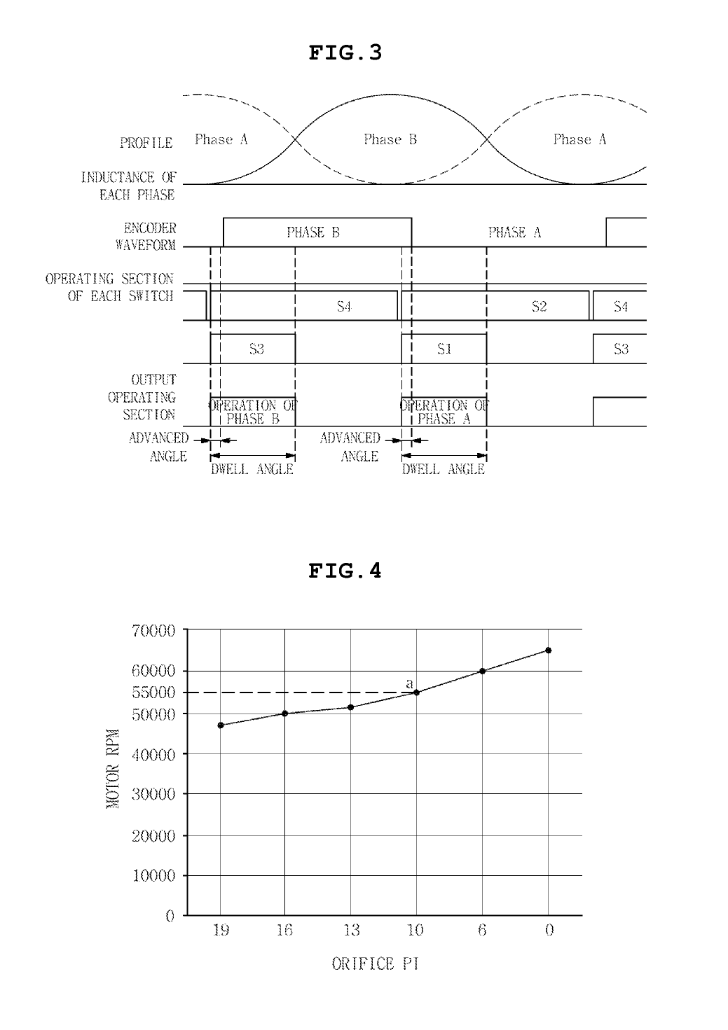

In more detail, as illustrated in FIG. 3, the processor 140 may control a switching operation of the motor driver 120, turn on a first lower switch S2 and a second lower switch S4 at each half cycle with a phase difference of 180 degrees, and turn on a first upper switch Si and a second upper switch S3 at the same cycle.

That is, 1) the controller 141 may adjust a turn-on time point of the first upper switch S1 and the first lower switch S2 through control of application timing for applying a PWM signal output from the PWM signal generating module 142 to the first upper/lower switches S1 and S2 to adjust an advanced angle (or a leading angle) of the phase winding A based on an encoder waveform.

In addition, the controller 141 may adjust turn-on time of the first upper switch S1 to adjust a dwell angle of the phase winding A.

In addition, 2) the controller 141 may adjust a turn-on time point of the second upper switch S3 and the second lower switch S4 through control of timing for applying a PWM signal output from the PWM signal generating module 142 to the second upper/lower switches S3 and S4 to adjust an advanced angle (or a leading angle) of the phase winding B.

In addition, the controller 141 may adjust turn-on time of the second upper switch S3 to adjust a dwell angle of the phase winding B.

Furthermore, when the rotational speed of the SRM 130 is equal to or more than the second reference speed, the controller 141 generates a second control signal for converting the driving state of the SRM to a stop state. In addition, the PWM signal generating module 142 generates a PWM signal for controlling the switching operation and applies the PWM signal to the motor driver 120 based on the second control signal.

As described above, according to an exemplary embodiment of the present disclosure, the driving apparatus of the SRM 130 may selectively convert the driving state of the SRM to a control or stop state of an advanced angle and so on based on the rotational speed of the SRM, thereby preventing increase in manufacturing costs due to manufacture of a suction fan using a material with excessive specification and so on.

The driving state of the SRM may be actively controlled along with change in rotational speed of the SRM according to a sealing degree of an intake of the suction fan so as to ensure the overall reliability of an SRM driving circuit.

The aforementioned processor 140, controller 141, and PWM signal generating module 142 may include an algorithm for performing the aforementioned functions and may be embodied as firmware, software, or hardware (e.g., a semiconductor chip or an application-specific integrated circuit).

Hereinafter, with reference to FIGS. 3 to 6, an apparatus for driving an SRM and a controlling method thereof according to an exemplary embodiment of the present disclosure will be described in more detail.

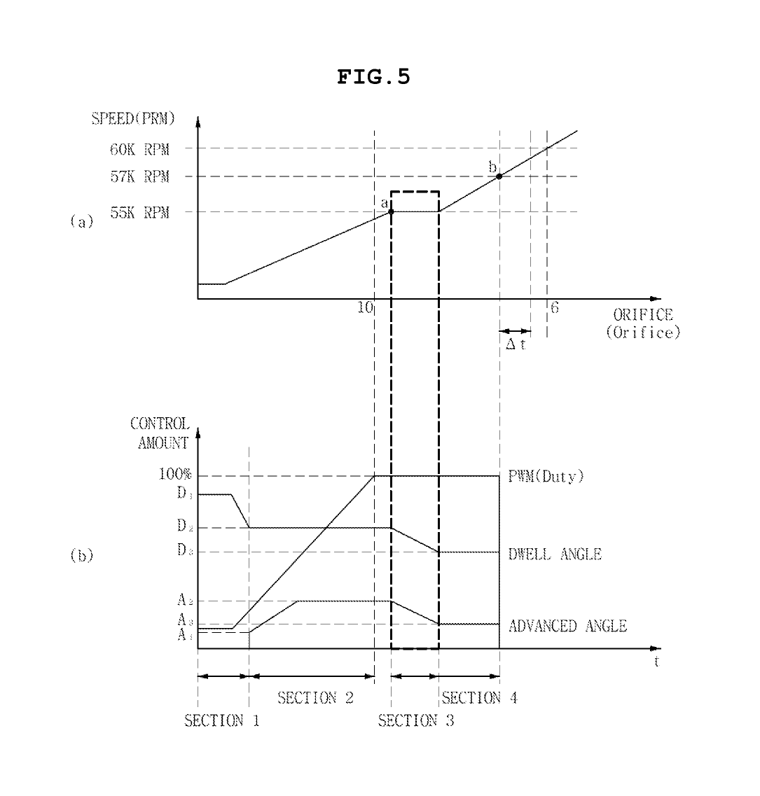

FIG. 4 is a diagram illustrating a relationship between a size of an orifice (hole) of an intake and rotational speed of an SRM according to an exemplary embodiment of the present disclosure, and FIG. 5A is a diagram illustrating a relationship between rotational speed of an SRM and a size of an orifice (hole) of an intake according to an exemplary embodiment of the present disclosure.

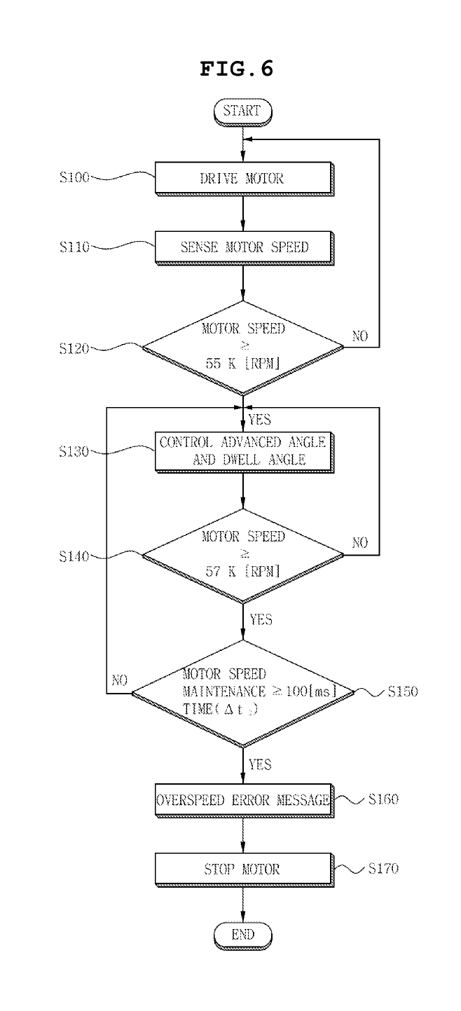

FIG. 5B is a diagram illustrating control of an advanced angle and dwell angle of an SRM according to rotational speed of the SRM, and FIG. 6 is a flowchart of a controlling method of a driving apparatus of an SRM according to an exemplary embodiment of the present disclosure.

Conventionally, when the rotational speed of the SRM 130 is increased to predetermined speed (point ‘a’ (about 55,000 RPM) of FIG. 3) or more, the suction fan may be damaged, which may be changed according to a material or shape of the air suction fan during driving of the air suction fan using a rotational force of the SRM 130. This is because, as the size of the orifice (hole) of the intake of the suction fan is gradually reduced to reduce air resistance, the rotational speed of the SRM 130 is increased.

Accordingly, as illustrated in FIGS. 5A and 5B, the controlling method of the driving apparatus of the SRM 130 according to an exemplary embodiment of the present disclosure includes applying an input voltage (a DC voltage) to each phase of the SRM 130 through a switching operation by the motor driver 120 and controlling a driving state of the SRM 130 through control of the switching operation based on the rotational speed of the SRM 130 by the processor 140.

As illustrated in FIGS. 5A and 5B, first, 1) when the SRM 130 is turned on by a user, the processor 140 controls a switching operation of the motor driver 120 to drive the SRM 130 (S100).

That is, the switching operation of the motor driver 120 is controlled to apply only a partial voltage to any of phase windings of the SRM 130 such that a stator (not shown) and a rotor (not shown) of the SRM 130 are moved to a predetermined position and made to a standby state (Section 1).

Here, the controller 141 may control the PWM signal generating module 142 to generate a PWM signal with a duty ratio of 4% and to apply (1 sec or less) the PWM signal to the motor driver 120 and may set a dwell angle to an initially set dwell angle D₁ (60% to 80% of a maximum angle). Accordingly, current flows in each phase winding of the SRM 130 and torque for rotation is generated until the rotor (not shown) is moved to a position corresponding to a maximum inductance value.

In addition, 2) the processor 140 controls a switching operation of the motor driver 120 and the SRM 130 reaches a normal driving state with initial acceleration as a start (section 2). Here, the dwell angle may be converted to a dwell angle D₂ of a normal driving state from the initially set dwell angle D₁ and control of the advanced angle is performed at a time point when the dwell angle is converted to the dwell angle D₂ of the normal driving state (that is, the advanced angle is increased with an initially set advanced angle (leading angle) A₁ as a start.

Here, the controller 141 may control the PWM signal generating module 142 to increase a duty ratio of a PWM signal applied to the switches S1 to S4 of the motor driver 120 at a time point when a dwell angle of each phase is changed to the dwell angle D₂ of the normal driving state from the initially set dwell angle D₁.

Accordingly, a total amount of current flowing in each phase may be increased due to increase in a duty ratio of the PWM signal at a time point when a total amount of current flowing in each phase winding is reduced due to change in the dwell angle, thereby achieving smooth acceleration characteristic through initial acceleration.

In addition, the controller 141 controls the PWM signal generating module 142 to perform control of an advanced angle so as to increase an advanced angle for a predetermined time period until an advanced angle A₂ of a normal driving state is reached with an initially set advanced angle A₁ as a start at a time point when the dwell angle is changed to the dwell angle D₂ of the normal driving state from the initially set dwell angle D₁.

As such, a time point when a voltage is applied to each phase winding may be put forward such that rise time of phase currents I_{A} and I_{B} of respective phases and input current I applied to the processor 140 is increased, and thus remarkable change (current peak) of the phase currents I_{A} and I_{B} and the input current I may be prevented, and the initially set advanced angle A₁ may be set between 5° and 10°.

Then 3) after the driving state of the SRM 130 reaches a normal driving state (section 3), the processor 140 compares the rotational speed of the SRM 130, transmitted from the rotor position sensor 150, with the first reference speed (S110 and S120).

That is, when the rotational speed of the SRM 130 is equal to or more than the first reference speed, the processor 140 controls the advanced angle or dwell angle of the SRM 130 through control of the switching operation of the motor driver 120 (S130). Here, the first reference speed may be rotational speed (about 55,000 RPM) of the SRM 130 when a size of an orifice of an intake of a suction fan is 10 pi, but is not limited thereto.

In more detail, when the rotational speed of the SRM 130 is equal to or more than the first reference speed, the controller 141 may control the advanced angle or dwell angle of the SRM 130 to generate a first control signal for maintaining the rotational speed of the SRM 130 as the first reference speed.

In addition, the PWM signal generating module 142 may generate a PWM signal for controlling the switching operation based on the first control signal and apply the PWM signal to a switching module of the motor driver 120.

Then the processor 140 compares the rotational speed of the SRM 130 and the second reference speed (S140). Here, when the rotational speed of the SRM 130 is equal to or more than the second reference speed, the processor 140 converts the driving state of the SRM 130 to a stop state through control of the switching operation of the motor driver 120.

Here, the second reference speed may be the rotational speed (about 57,000 RPM) of the SRM 130 at which the suction fan is damaged, but is not limited thereto.

That is, when the rotational speed of the SRM 130 is equal to or more than the second reference speed, the processor 140 generates an overspeed error message (S160) and controls the switching operation of the motor driver 120 to convert the driving state of the SRM 130 to a stop state (S170).

In more detail, when the rotational speed of the SRM 130 is equal to or more than the second reference speed, the controller 141 generates a second control signal for converting the driving state of the SRM 130 to a stop state.

In addition, the PWM signal generating module 142 generates a PWM signal for controlling the switching operation based on the second control signal and applies the PWM signal to a switching module of the motor driver 120.

That is, the PWM signal generating module 142 reduces a duty ratio of the PWM signal applied to the switching module of the motor driver 120 and converts the driving state of the SRM 130 to a stop state (PWM Duty=0%, RPM=0).

Here, the processor 140 may determine whether a state in which the rotational speed of the SRM 130 is equal to or more than the second reference speed is maintained for first reference time (about 100 ms) (section Δt) and convert the driving state of the SRM 130 to a stop state (S150).

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to be within the scope of the disclosure, and the detailed scope of the disclosure will be disclosed by the accompanying claims.

What is claimed is:

1. An apparatus for driving a switched reluctance motor (SRM), the apparatus comprising:
a motor driver for applying an input voltage to each phase of the SRM to drive the SRM through a switching operation; and
a processor for controlling a driving state of the SRM through control of the switching operation based on a rotational speed of the SRM.

2. The apparatus of claim 1, wherein:
the processor controls an advanced angle or dwell angle of the SRM through control of the switching operation when the rotational speed of the SRM is equal to or more than first reference speed; and
the processor converts the driving state of the SRM to a stop state through control of the switching operation when the rotational speed of the SRM is equal to or more than second reference speed.

3. The apparatus of claim 2, wherein the processor converts the driving state of the SRM to a stop state when the rotational speed of the SRM is equal to or more than the second reference speed and the rotational speed of the SRM is maintained for first reference time.

4. The apparatus of claim 1, wherein the motor driver includes:
a switching module for applying a direct current (DC) voltage to each phase winding of the SRM through the switching operation; and
a current circulating module for circulating current flowing in each phase winding of the SRM in a predetermined direction during the switching operation.

5. The apparatus of claim 2, wherein the processor includes:
a controller for generating a first control signal for adjusting the advanced angle or dwell angle of the SRM when the rotational speed of the SRM is equal to or more than the first reference speed; and
a pulse width modulation (PWM) signal generating module for transmitting a PWM signal for controlling the switching operation to the motor driver based on the first control signal.

6. The apparatus of claim 5, wherein the PWM signal generating module controls a duty ratio of the PWM signal and timing for transmitting the PWM signal to the motor driver based on the first control signal.

7. The apparatus of claim 5, wherein:
the controller generates a second control signal for converting the driving state of the SRM to the stop state when the rotational speed of the SRM is equal to or more than the second reference speed; and
the PWM signal generating module applies the PWM signal for controlling the switching operation to the motor driver based on the second control signal.

8. The apparatus of claim 1, further comprising a rotor position sensor for sensing the rotational speed of the SRM and transmitting the rotational speed to the processor.

9. A controlling method of an apparatus for driving a switched reluctance motor (SRM), the method comprising:
applying an input voltage to each phase of the SRM to drive the SRM through a switching operation, by a motor driver; and
controlling a driving state of the SRM through control of the switching operation based on a rotational speed of the SRM, by a processor.

10. The method of claim 9, wherein the controlling includes:
controlling an advanced angle or dwell angle of the SRM through control of the switching operation when the rotational speed of the SRM is equal to or more than first reference speed; and
converting the driving state of the SRM to a stop state through control of the switching operation when the rotational speed of the SRM is equal to or more than second reference speed.

11. The method of claim 10, wherein the controlling of the advanced angle or dwell angle of the SRM includes:
generating a first control signal for adjusting the advanced angle or dwell angle of the SRM when the rotational speed of the SRM is equal to or more than the first reference speed, by a controller; and
generating a PWM signal for controlling the switching operation and transmitting the PWM signal to the motor driver based on the first control signal, by a PWM signal generating module.

12. The method of claim 11, wherein the converting of the driving state of the SRM includes:
generating a second control signal for converting the driving state of the SRM to the stop state when the rotational speed of the SRM is equal to or more than the second reference speed, by the controller; and
generating the PWM signal for controlling the switching operation and applying the PWM signal to the motor driver based on the second control signal, by the PWM signal generating module.

13. The method of claim 9, further comprising sensing the rotational speed of the SRM and transmitting the rotational speed to the processor, by a rotor position sensor.
